(19) United States
(12) Patent Application Publication
(10) Pub. No.: US 2005/0114579 A1
(43) Pub. Date: May 26, 2005

(54) [SYSTEM FOR ACCESSING A PLURALITY OF DEVICES BY USING A SINGLE BUS AND CONTROL APPARATUS THEREIN]

(76) Inventors: GENG-LIN CHEN, HSINCHU CITY (TW); YING-CHIH YANG, HSINCHU CITY (TW); YUAN-NING CHEN, TAIPEI COUNTY (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/708,805

(22) Filed: Mar. 26, 2004

(30) Foreign Application Priority Data
Nov. 20, 2003 (TW) 92132502

(51) Int. Cl. G06F 13/00

(52) U.S. Cl. 710/305; 710/113

(57) ABSTRACT

The present invention provides a system for accessing a plurality of devices by using a single bus and a control apparatus therein. The system comprises a control apparatus, a bus isolator, a shared bus, a first device and a second device. The control apparatus controls to switch between the first device and the second device so as to share the shared bus, and also optionally use the bus isolator to isolate the second device from the shared bus according to whether the first device is selected. Since a plurality of devices is accessed through a single bus, a number of buses as well as a pin count in an integrated circuit can be reduced.

### CROSS REFERENCE TO RELATED APPLICATIONS

This application claims the priority benefit of Taiwan application serial no.92132502, filed on Nov. 20, 2003.

### BACKGROUND OF INVENTION

1. Field of the Invention

The present invention relates to a bus system for accessing a plurality of devices. More particularly, the present invention relates to a system for accessing a plurality of devices by using a single bus and a control apparatus therein.

2. Description of the Related Art

With continuous progress in semiconductor fabrication technique and rapid development of information technologies, the capacity of storage medium is increased while the physical device for holding the data is getting smaller. For example, flash memory card is now a common large capacity storage device that occupies a small volume. With the growing popularity of fast-access flash memory cards, the a card reader thus plays an essential role.

At present, a card reader is a built-in feature for most multi-media devices such as a DVD player, a digital camera, a digital camcorder and so on. To have a built-in card reader with the DVD player, card reader related integrated circuits (IC) and pins must be integrated into the DVD player so that the DVD player manages to control the card reader for data transmission. However, a card reader needs to be equipped with large pin count. Hence, integrating a card reader into a DVD player or other multimedia devices often involves a raise of fabrication cost thereby, and the frequency bands of the pins are not sharable with other memory units in the DVD player.

### SUMMARY OF INVENTION

Accordingly, at least one objective of the present invention is to provide a system for accessing a plurality of devices via a single bus. The present invention permits a number of devices to share the same bus so that the number of buses as well as integrated circuit pins can be reduced.

At least a second objective of the present invention is to provide a control apparatus that can be used in the aforementioned system for accessing a plurality of devices through a single bus. The system relies on the control apparatus to determine the authority of a particular device for using the bus. That means, the control apparatus arbitrates and switches between various devices so that a single bus can be used to access data from a multiple of devices.

To achieve these and other advantages and in accordance with the purpose of the invention, as embodied and broadly described herein, the invention provides a system for accessing a plurality of devices by using a single bus. The system comprises a first device, a second device, a shared bus, a bus isolator and a control apparatus. The shared bus is coupled to the first device. The bus isolator is coupled to the shared bus and the second device for isolating the second device from the shared bus or connecting the second device to the shared bus. The control apparatus is coupled to the shared bus. When the control apparatus needs to access the first device, the bus isolator is activated to isolate the second bus from the shared bus. On the other hand, when the control apparatus needs to access the second device, the bus isolator is activated to connect the second device to the shared bus.

The present invention also provides a control apparatus for accessing a plurality of devices through a single bus. The control apparatus comprises a bus exchanger and a bus arbitrator. The bus exchanger is coupled to a shared bus for switching the priority of the shared bus users. The bus arbitrator is coupled to the bus exchanger. When the control apparatus needs to access a first device, the bus arbitrator controls the bus exchanger to connect the shared bus with a circuit internally linked to the first device. When the control apparatus needs to access a second device, the bus arbitrator controls the bus exchanger to connect the shared bus with another circuit internally linked to the second device.

According to one preferred embodiment of the present invention, a definite isolation period must pass after the control apparatus has finished accessing the first device before the bus exchanger can use the shared bus to access the second device. The second device can be a memory card or a card reader and the first device can be a memory device.

In brief, the control apparatus according to the present invention is capable of switching between a number of devices and hence accessing each devices through a single bus. According to the types of memory devices, bus isolators are used to isolate other devices from the bus so that interference from the signals of other devices and memory is prevented. Ultimately, the number of buses as well as the pin count in the integrated circuit is reduced.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating a system for accessing a plurality of devices using a single bus according to a first preferred embodiment of the present invention.

FIG. 2 is a block diagram illustrating a system for accessing a memory and a card reader using a single bus according to a second preferred embodiment of the present invention.

FIG. 3 is a block diagram illustrating a system for accessing a ROM and a flash memory card through a built-in card reader using a single bus according to a third preferred embodiment of the present invention.

FIG. 4 is a block diagram illustrating a system for accessing a ROM, a SDRAM and a flash memory card through a built-in card reader using a single bus according to a fourth preferred embodiment of the present invention.

FIG. 5 is a block diagram illustrating a system for accessing a ROM, a SDRAM and a card reader using a single bus according to a fifth preferred embodiment of the present invention.

FIG. 6 is a block diagram illustrating a card reader isolated by a bus isolator according a sixth preferred embodiment of the present invention.

FIG. 7 is a timing diagram illustrating various internal signals of a system for accessing a plurality of devices using a single bus according to one preferred embodiment of the present invention.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

FIG. 1 is a block diagram of a system for accessing a plurality of devices using a single bus according to a first preferred embodiment of the present invention. As shown in FIG. 1, the system comprises a first device 160, a second device 180, a shared bus 150, a bus isolator 170 and a control apparatus 100. The shared bus 150 is coupled to the first device 160. The bus isolator 170 is coupled to the shared bus 150 and the second device 180 for isolating the second device 180 from the shared bus 150 or connecting the second device 180 to the shared bus 150. The control apparatus 100 is coupled to the shared bus 150. When the control apparatus needs to access the first device 160, the bus isolator 170 is activated to isolate the second device 180 from the shared bus 150. On the other hand, when the control apparatus needs to access the second device 180, the bus isolator is activated to connect the second device 180 with the shared bus 150.

In the aforementioned embodiment, the control apparatus further comprise a bus exchanger 106 and a bus arbitrator 108. The bus exchanger 106 is coupled to the shared bus 150 for switching the priority for using the shared bus 150. The bus arbitrator 108 is coupled to the bus exchanger 106. When the control apparatus 100 needs to access the first device 160, the bus arbitrator 108 controls the bus exchanger 108 to connect the shared bus 150 with a circuit internally linked to the first device 160. When the control apparatus 100 needs to access the second device 180, the bus arbitrator 108 controls the bus exchanger 106 to connect the shared bus 150 to a circuit internally linked to the second device 180.

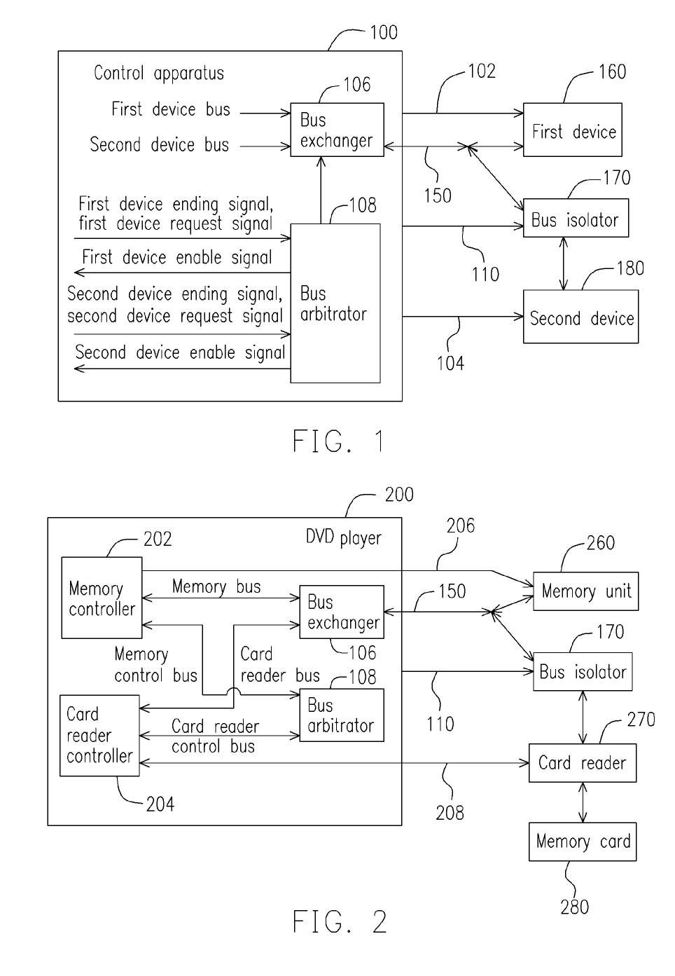

FIG. 2 is a block diagram of a system for accessing a memory and a card reader using a single bus according to a second preferred embodiment of the present invention. As shown in FIGS. 1 and 2, the first device 160 is a memory 260, the second device 180 is a card reader 270 and the control apparatus 100 is a DVD player 200. With this setup, a memory controller 202 controls the memory 260 through a memory control bus 206 and a card controller 204 controls the card reader 270 through a card reader control bus 208. If the DVD player 200 is taking in data from the memory 260 when data from a memory card 280 needs to be accessed, the bus arbitrator 108 can activate the bus exchanger 106 to switch the authority for using the shared bus 150. In other words, the shared bus 106 originally used by the memory 260 is temporarily cut off and then turned over to the card reader 270. If the memory 260 is a synchronous dynamic random access memory (SDRAM) with strict correct signaling demand operating at a data transmission rate of 133 MHz, the DVD player 200 will issue a triggering signal via the bus isolator control bus 110 to activate the bus isolator 170 first. After activating the bus isolator 170, the card reader 270 is isolated from the shared bus 150 to prevent the signals emitted by the card reader 270 from interfering with the SDRAM. On the contrary, if the memory 260 is a conventional ROM device, the DVD player 200 can issue a signal via the bus isolator control bus 110 to switch off the bus isolator 170 so that the card reader 270 can connect with the shared bus.

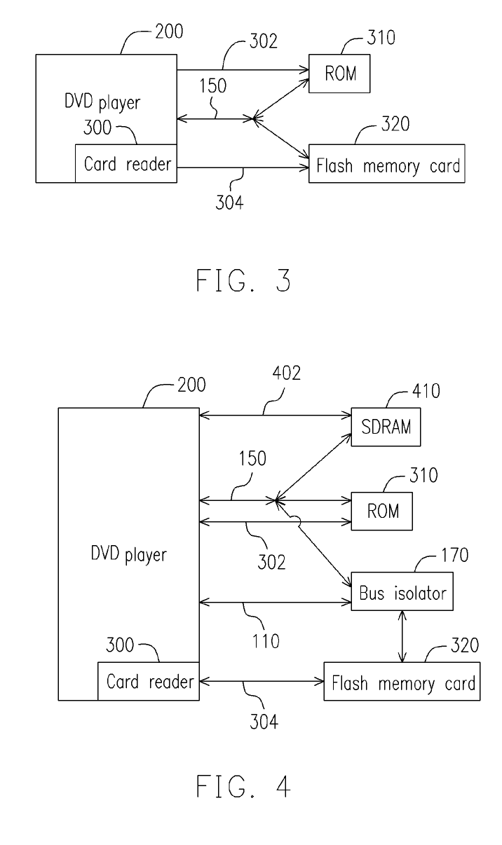

FIG. 3 is a block diagram illustrating a system for accessing a ROM and a flash memory card through a built-in card reader using a single bus according to a third preferred embodiment of the present invention. As shown in FIG. 3, the DVD player 200 has a built-in card reader 300 in this embodiment. When the DVD player 200 needs to access the data stored in a ROM 310, the DVD player 200 controls the ROM 310 through a ROM control bus 302 so that the data is read from the ROM 310 and transmitted back via the shared bus 150. When the DVD player 200 needs to access the data stored in the flash memory card 320, the DVD player 200 controls the flash memory card 320 through a flash memory card control bus 304. However, the shared bus 150 must wait for a pre-defined isolation period before the authority for using the shared bus 150 is switched from the ROM 310 to the flash memory card 320. In other words, a pre-defined isolation period must pass before the flash memory card 320 being capable of using the shared bus 150 to begin data transmission.

FIG. 4 is a block diagram illustrating a system for accessing a ROM, a SDRAM and a flash memory card through a built-in card reader using a single bus according to a fourth preferred embodiment of the present invention. As shown in FIG. 4, an additional SDRAM 410 is used in this embodiment. The DVD player 200 uses the shared bus 150 to read data from the SDRAM 410 and ROM 310 and to access the flash memory card 320. It should be noted that only one of the devices could use the shared bus 360 at any one time. That means, after the DVD player 200 has read data from the ROM 310 but before the shared bus 360 can again be used to access the data within the SDRAM 410, a pre-defined isolation period must pass. In general, the signaling requirement of the SDRAM 410 is rather strict. To prevent any signal interference between the flash memory card 320 and the SDRAM 410, the DVD player 200 issues a signal via the control bus 110 to trigger the bus isolator 170 and isolate the flash memory card 320 from the shared bus 150.

In the aforementioned embodiment, the purpose of using the bus isolator 170 is to prevent any data error resulting from a mutual interference of the signals between the flash memory card 320 and the SDRAM 410. However, if the signaling requirement of the ROM 310 for using the shared bus 150 is not too strict, the bus isolator 170 can be shut off immediately. In other words, after reading data from the SDRAM 410, the DVD player 200 immediately issues a signal via the control bus 110 to shut down the bus isolator 170 so that the flash memory card 320 can quickly use the shared bus 150 to carry out data transmission.

FIG. 5 is a block diagram of a system for accessing a ROM, a SDRAM and a card reader using a single bus according to a fifth preferred embodiment of the present invention. As shown in FIG. 5, the DVD player 200 has an externally connected card reader 270 for reading data from the flash memory card 320. In the present embodiment, the DVD player 200 can control the SDRAM 410, the ROM 310 and the card reader 270 through the SDRAM control bus 402, the ROM control bus 302 and the card reader control bus 208 respectively. Hence, a single shared bus 150 can be used to transmit data. However, only one of the devices can use the shared bus 150 at any particular time. In other words, data from the SDRAM 410, ROM 310 and the flash memory card 320 cannot be transmitted at the same time. Furthermore, the switching of the shared bus 150 between different users, for example, from a SDRAM 410 user to a ROM 310 user or from a ROM 310 user to a flash memory card 320 user is accompanied by the passage of a pre-defined isolation period. Data transmission using the shared bus 150 is permitted to proceed only at the expiry of the pre-defined isolation period.

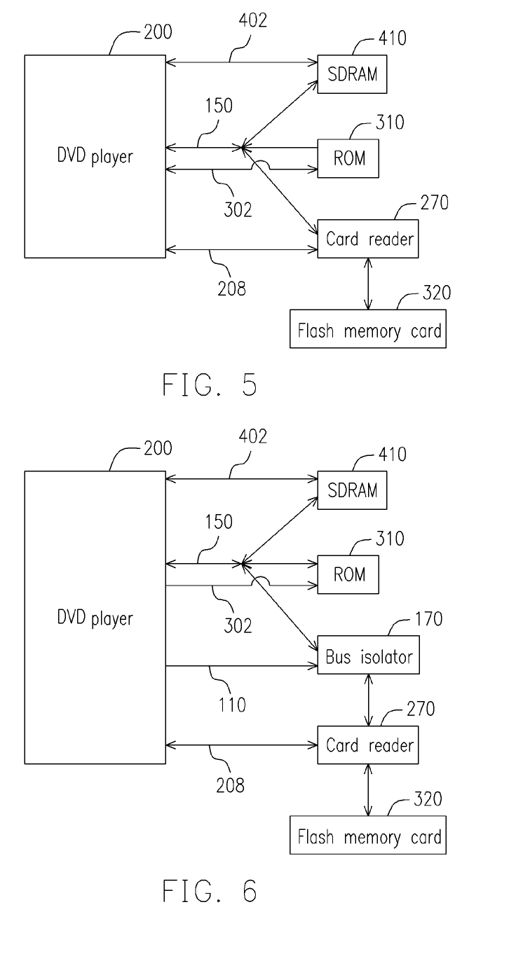

FIG. 6 is a block diagram illustrating a card reader isolated by a bus isolator according to a sixth preferred embodiment of the present invention. As shown in FIG. 6, the DVD player 200 issues a triggering signal via the control bus 110 to the bus isolator 170 so that the card reader 170 is isolated from the shared bus 150. This prevents electrical signals produced by the card reader 270 from interfering with the signals inside the SDRAM 410.

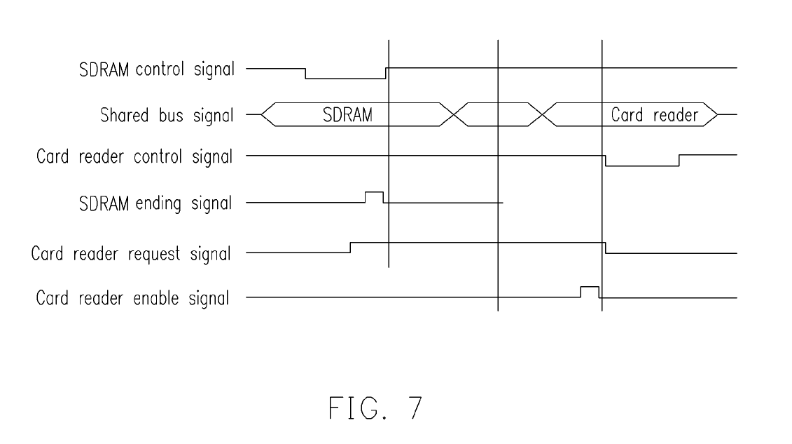

FIG. 7 is a timing diagram showing various internal signals of a system for accessing a plurality of devices using a single bus according to one preferred embodiment of the present invention. As shown in FIGS. 1 and 7, the control apparatus 100 according to the present invention sets up a pre-defined isolation period between the end of data access by the first device 160 and the start of data access by the second device 180. The bus exchanger 106 must wait for the passage of the pre-defined isolation period before the authority for using the shared bus 150 is passed from the first device 160 to the second device 180. For example, if the first device 160 is a SDRAM and the second device is a card reader and the card reader needs to take back the control of the shared bus 150 from the SDRAM, the bus arbitrator 108 will receive a request signal from the card reader. As soon as the bus arbitrator 108 receives a termination signal from the SDRAM, the bus arbitrator 108 controls the bus exchanger 106 to initialize the release of the control of the shared bus 150 from the SDRAM. After receiving the termination signal from the SDRAM, the SDRAM will continue to use the shared bus 150 until the passage of a pre-defined period. During this period, the card reader issues request signals for the shared bus 150 repetitively. However, due to the high impedance effect within this period, the bus arbitrator 108 will ignore the request signals issued by the card reader. At the end of the pre-defined period, that is, the SDRAM has already stopped using the shared bus 150, the arbitrator 108 controls the bus exchanger 106 to perform an initialization of the card reader for using the shared bus. After another preset period, the card reader will pick up a card reader enable signal from the bus arbitrator 108 so that the card reader may proceed to use the shared bus 150.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A system for accessing a plurality of devices using a single bus, comprising:
a first device;
a second device;
a shared bus, coupled to the first device;
a bus isolator, coupled to the shared bus and the second bus for isolating the second device from the shared bus or connecting the second device to the shared bus; and
a control apparatus coupled to the shared bus so that the bus isolator isolates the second device from the shared bus when the control apparatus needs to access the first device and the bus isolator connects the second device with the shared bus when the control apparatus needs to access the second device.

2. The system of claim 1, wherein the control apparatus further comprises:
a bus exchanger, coupled to the shared bus for switching the authority for the shared bus between different devices; and
a bus arbitrator, coupled to the bus exchanger so that the bus arbitrator controls the bus exchanger to connect the shared bus with a circuit internally linked to the first device when the control apparatus needs to access the first device and the bus arbitrator controls the bus exchanger to connect the shared bus with a circuit internally linked to the second device when the control apparatus needs to access the second device.

3. The system of claim 2, wherein a pre-defined isolation period must pass before the bus exchanger is permitted to switch the device for authority for the shared bus.

4. The system of claim 1, wherein the second device comprises a memory card compatible device.

5. The system of claim 4, wherein the memory card compatible device is either a memory card or a card reader.

6. The system of claim 1, wherein the first device comprises a memory device.

7. A control apparatus for accessing a plurality of devices through a single bus, the control apparatus connects to a first device through a shared bus and the control apparatus also connects to a second device through the shared bus and a bus isolator, the control apparatus comprising:
a bus exchanger, coupled to the shared bus for switching the authority of device for the shared bus; and
temptempa bus arbitrator coupled to the bus exchanger such that the bus arbitrator controls the bus exchanger to connect with a circuit internally linked to the first device and to activate the bus isolator to isolate the second device from the shared bus when the control apparatus needs to access the first device and the bus arbitrator controls the bus exchanger to connect with a circuit internally linked related to the second device when the control apparatus needs to access the first device.

8. The control apparatus of claim 7, wherein the bus exchanger is set to wait for the passage of a pre-defined isolation period lasting from the end of accessing the first device to the start of accessing the second device before switching the control of the shared bus from the first device to the second device.

9. The control apparatus of claim 7, wherein the second device comprises a memory compatible device.

10. The control apparatus of claim 7, wherein the memory compatible device is either a memory card or a card reader.

11. The control apparatus of claim 7, wherein the first device comprises a memory unit.

12. A system for accessing a plurality of devices through a single bus, comprising:
a memory unit;
a memory card compatible device;
a shared bus, coupled to the memory unit; and
a control apparatus coupled to the shared bus such that the control apparatus controls the shared bus to connect with a circuit internally linked to the first device when the control apparatus needs to access the first device and the control apparatus controls the shared bus to connect with a circuit internally linked to the second device when the control apparatus needs to access the second device.

13. The system of claim 12, wherein a pre-defined isolation period must pass before the control apparatus is permitted to access the second device through the shared bus.

14. The system of claim 12, wherein the memory card compatible device is either a memory card or a card reader.

15. The system of claim 12, wherein the memory unit comprises read-only memory.
